(19) United States
(12) Patent Application Publication
(10) Pub. No.: US 2021/0368239 A1
(43) Pub. Date: Nov. 25, 2021

(54) DISTRIBUTING METHOD, SYSTEM, EDGE NODE, AND CENTRAL SCHEDULING SYSTEM FOR STREAMING MEDIA RESOURCE

(71) Applicant: WANGSU SCIENCE & TECHNOLOGY CO., LTD., Shanghai (CN)

(72) Inventors: Guocong DAI, Shanghai (CN); Jinxian CHEN, Shanghai (CN)

(21) Appl. No.: 16/466,789

(22) PCT Filed: Jun. 14, 2018
(86) PCT No.: PCT/CN2018/091209

§ 371 Date: Jun. 5, 2019

(30) Foreign Application Priority Data
May 14, 2018 (CN) 201810456611.5

(51) Int. Cl. H04N 21/472; H04N 21/458; H04N 21/433

(52) U.S. Cl. CPC H04N 21/472; H04N 21/4331; H04N 21/458

(57) ABSTRACT

The disclosure discloses a distributing method, a system, an edge node, and a central scheduling system for a streaming media resource, where the method includes that: a pull-stream edge node receives a resource acquisition request that directs to a target streaming media resource and is sent from a pull-stream client terminal; if the target streaming media resource is not stored at the pull-stream edge node, the-pull-stream edge node sends a pull-stream query request to a central scheduling system, and receives the query result fed back from the central scheduling system; where the query result determines the target push-stream edge node storing the target streaming media resource or the target pull-stream edge node storing the target streaming media resource; the pull-stream edge node can obtain the target streaming media resource from the target push-stream edge node or the target pull-stream edge node determined by the query result, and provide the obtained target streaming media resource to the pull-stream client terminal. The technical solution provided by the disclosure can reduce network traffic consumption inside the CDN.

### TECHNICAL FIELD

The present disclosure relates to the field of Internet technologies and, in particular, to a distributing method and system, an edge node, and a central scheduling system for a streaming media resource.

### BACKGROUND

A current content delivery network (CDN) architecture usually includes a client terminal, an edge node, a source node, and a level 2 cache node. Referring to FIG. 1, in a live broadcast service, the client terminal may include a push-stream client terminal used by an anchor and a pull-stream client terminal used by a viewer, and the edge node may also include a push-stream edge node and a pull-stream edge node. When the push-stream client terminal needs to upload the live video, the push-stream edge node can receive the video stream pushed by the push-stream client terminal, and then the push-stream edge node can further push the video stream to a source node, so that the source node can store the video stream. Subsequently, when the stream client terminal needs to play the live video, the resource acquisition request may be sent to the pull-stream edge node, so that the pull-stream edge node can obtain the corresponding video stream from the source node. When the video stream is obtained, the source node forwards the video stream to the level 2 cache node first, and then the level 2 cache node sends the video stream to the pull-stream edge node. Finally, the pull-stream edge node can feed back the video stream to the pull-stream client terminal for displaying.

In view of the above, a resource distribution process in the CDN architecture in existing technologies needs to forward resources between multiple nodes in the CDN, and has a long link path, which can increase the live broadcast delay and cause a huge network traffic consumption within the CDN.

### SUMMARY

The purpose of the present disclosure is to provide a distributing method, a system, an edge node, and a central scheduling system for a streaming media resource, which can reduce network traffic consumption within the CDN.

In order to achieve the above object, the present disclosure provides a method for distributing a streaming media resource, where the method includes that: a pull-stream edge node receives a resource acquisition request that directs to a target streaming media resource and is sent from a pull-stream client terminal; when the target streaming media resource is not stored at the pull-stream edge node, the pull-stream edge node sends a pull-stream query request to a central scheduling system, and receives a query result fed back from the central scheduling system, where the query result indicates the target push-stream edge node that stores the target streaming media resource or the target pull-stream edge node that stores the target streaming media resource; and the pull-stream edge node can obtain the target streaming media resource from the target push-stream edge node or the target pull-stream edge node indicated by the query result, and provide the obtained target streaming media resource to the pull-stream client terminal.

In order to achieve the above object, the present disclosure further provides a pull-stream edge node, where the pull-stream edge node includes a resource acquisition-request receiving unit configured to receive a resource acquisition request that directs to the target streaming media resource and is sent by the pull-stream client terminal; a query unit configured to send a pull-stream query request to the central scheduling system if the target streaming media resource is not stored at the pull-stream edge node, and receive a query result fed back from the central scheduling system, where the query result indicates the target push-stream edge node that stores the target streaming media resource or the target pull-stream edge node that stores the target streaming media resource; and a resource acquisition unit configured to obtain the target streaming media resource from the target push-stream edge node or the target pull-stream edge node indicated by the query result.

To achieve the above object, another aspect of the present disclosure is to provide a method for distributing a streaming media resource, where the method includes: after receiving a push-stream request sent by a push-stream client terminal, the push-stream edge node stores a target streaming media resource directed to by the push-stream request, and uploads a resource identifier of the streaming media resource and own node information of the push-stream edge node to a central scheduling system, so that when receiving the pull-stream query request sent by the pull-stream edge node, the central scheduling system feeds back the node information of the push-stream edge node to the pull-stream edge node; and after receiving the pull-stream request that directs to the target streaming media resource and is sent by the pull-stream edge node, the push-stream edge node feeds back the streaming media resource to the pull-stream edge node.

To achieve the above objective, another aspect of the present disclosure further provides a push-stream edge node, where the push-stream edge node includes: an information uploading unit configured to store the streaming media resource directed to by the push-stream request and upload an resource identifier of the streaming media resource and node information of the push-stream edge node to the central scheduling system, after the push-stream edge node receiving the push-stream request sent from the push-stream client terminal, so that when receiving the pull-stream query request sent by the pull-stream edge node, the central scheduling system feeds back the node information of the push-stream edge node to the pull-stream edge node; and a resource feedback unit, configured to feed back the streaming media resource to the pull-stream edge node, after receiving the pull-stream request that directs to the streaming media resource and is sent by the pull-stream edge node.

In order to achieve the above object, another aspect of the present disclosure is to provide a method for distributing a streaming media resource, where the method includes: when a push-stream edge node receives a push-stream request sent by a push-stream client terminal, a central scheduling system receives push-stream information uploaded by the push-stream edge node, the push-stream information including a resource identifier of the streaming media resource directed to by the push-stream request and node information of the push-stream edge node; the central scheduling system receives the pull-stream query request that directs to the target streaming media resource and is sent by the pull-stream edge node, and feeds back the query result to the pull-stream edge node, where the query request determines the target push-stream edge node that stores the target streaming media resource or the target pull-stream edge node that stores the target streaming media resource, so that the pull-stream edge node can obtain the target streaming media resource from the target push-stream edge node or the target pull-stream edge node indicated by the query result.

In order to achieve the above object, the present disclosure further provides a central scheduling system, where the system includes: a push-stream information receiving unit configured to after the push-stream edge node receives a push-stream request sent by a push-stream client terminal, receive push-stream information uploaded by the push-stream edge node, where the push-stream information includes a resource identifier of the streaming media resource directed to by the push-stream request and node information of the push-stream edge node; and a query result feedback unit configured to receive the pull-stream query request that directs to the target streaming media resource and is sent by the pull-stream edge node, and feed back the query result to the pull-stream edge node, the query request determines the target push-stream edge node that stores the target streaming media resource or the target pull-stream edge node that stores the target streaming media resource, so that the pull-stream edge node can obtain the target streaming media resource from the target push-stream edge node or the target pull-stream edge node indicated by the query result.

To achieve the above objective, another aspect of the present disclosure further provides a distribution system for streaming media resource, where the system includes a push-stream edge node, a pull-stream edge node, a level 2 cache node, a source node, and a central scheduling system, where the push-stream edge node and the source node have the same configuration information, and the pull-stream edge node and the level 2 cache node have the same configuration information; and the push-stream edge node, the pull-stream edge node, and the central scheduling system are respectively configured to perform the corresponding steps described above.

It can be seen from the above that in the technical solution provided by the present disclosure the source node and the push-stream edge node are at equal level, and the level 2 cache node and the pull-stream edge node are at equal level, thereby avoiding a forwarding process of a large number of resources inside the CDN. Specifically, after receiving the push-stream request sent by the push-stream client terminal, the push-stream edge node may not push the corresponding streaming media resource to the source node, but stores the streaming media resource locally, and uploads a resource identifier of the streaming media resource and own node information of the push-stream edge node to the central scheduling system, to indicate that the streaming media resource is currently stored at the push-stream edge node. After receiving the resource acquisition request sent by the pull-stream client terminal, if the pull-stream edge node does not store the corresponding streaming media resource locally, the pull-stream edge node may send the pull-stream query request to the central scheduling system to obtain the node that currently stores the streaming media resource from the central scheduling system. If the central scheduling system feeds back the node information of the push-stream edge node to the pull-stream client terminal, the pull-stream edge node can directly obtain the corresponding streaming media resource from the push-stream edge node. In this way, the push-stream edge node undertakes both the service of edge node and the service of source node. In addition, after obtaining the required streaming media resource, the stream edge node can perform the storage of the obtained streaming media resource locally, and after the storage, upload the resource identifier and its own node information to the central scheduling system. In this way, if other stream edge nodes need to obtain the streaming media resource, the streaming media resource can be directly obtained from the pull-stream edge node where the streaming media resource is stored, so that the pull-stream edge node not only undertakes the service of the edge node and undertakes the service of the level 2 cache node at the same time. It can be seen that by making the push-stream edge node and the source node at equal level and making the pull-stream edge node and the level 2 cache node at equal level, the process of forwarding a large number of resources within the CDN can be avoided, thereby reducing the network traffic consumption inside the CDN, shortening the length of the resource transmission link and reducing the delay.

### DESCRIPTION OF THE DRAWINGS

In order to more clearly illustrate the technical solutions in embodiments of the present disclosure, the drawings used in the description of the embodiments are briefly described below. It is obvious that the drawings in the following description are only some embodiments of the present disclosure. Other drawings may also be obtained from those of ordinary skill in the art in view of the drawings without any creative effort.

FIG. 1 is a diagram of a system architecture of a CDN in existing technologies;

FIG. 2 is a diagram of a system for distributing a streaming media resource according to some embodiments of the present disclosure;

FIG. 3 is a flowchart of a method for distributing a streaming media resource implemented by a pull-stream edge node according to some embodiments of the present disclosure;

FIG. 4 is a structural diagram of a pull-stream edge node according to some embodiments of the present disclosure;

FIG. 5 is a flowchart of a method for distributing a streaming media resource implemented by a push-stream edge node according to some embodiments of the present disclosure; and

FIG. 6 is a flowchart of a method for distributing a streaming media resource implemented by a central scheduling system according to some embodiments of the present disclosure.

### DETAILED DESCRIPTION

The embodiments of the present disclosure are further described in detail below with reference to the accompanying drawings.

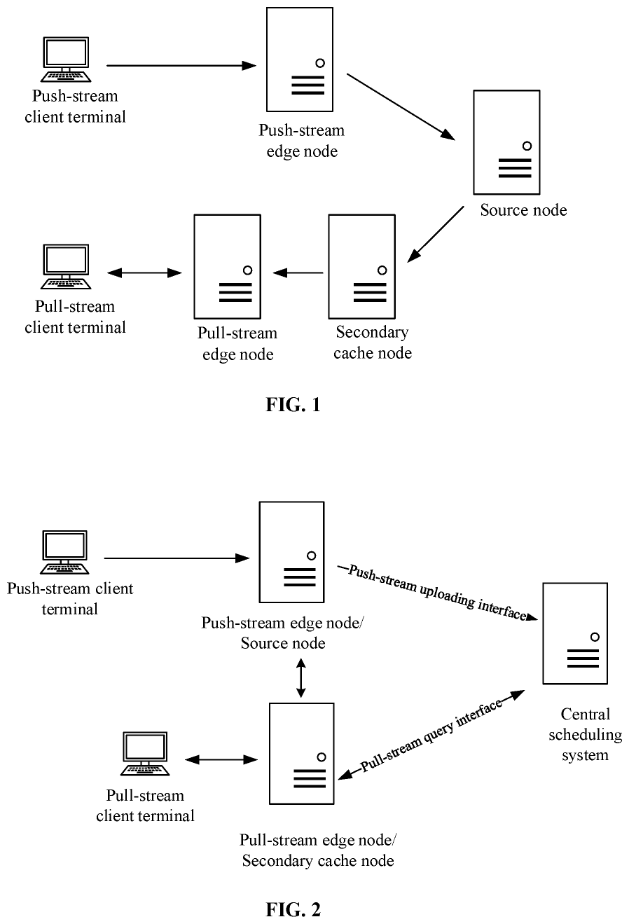

The present disclosure provides a system for distributing a streaming media resource. Referring to FIG. 2, the system includes a push-stream edge node, a pull-stream edge node, a level 2 cache node, a source node, and a central scheduling system. In the present embodiment, the push-stream edge node and the source node have the same configuration information, and the pull-stream edge node and the level 2 cache node have the same configuration information. The same configuration information may refer to that the hardware resources and software resources of the server in the node are consistent, and the domain names in the nodes are also consistent for the same streaming media resource. In this way, the push-stream edge node and the pull-stream edge node can undertake the service of the normal edge node, and at the same time, the push-stream edge node can also undertake the service of the source node, and the pull-stream edge node can also undertake the service of the level 2 cache node. As shown in FIG. 2, in the embodiment, the central scheduling system may provide a push-stream uploading interface, and the push-stream uploading interface may receive the push-stream information uploaded by the push-stream edge node. In addition, the central scheduling system may further provide a pull-stream query interface, where the pull-stream query interface may receive a pull-stream query request sent by the pull-stream edge node, and feed back the corresponding query result to the pull-stream edge node.

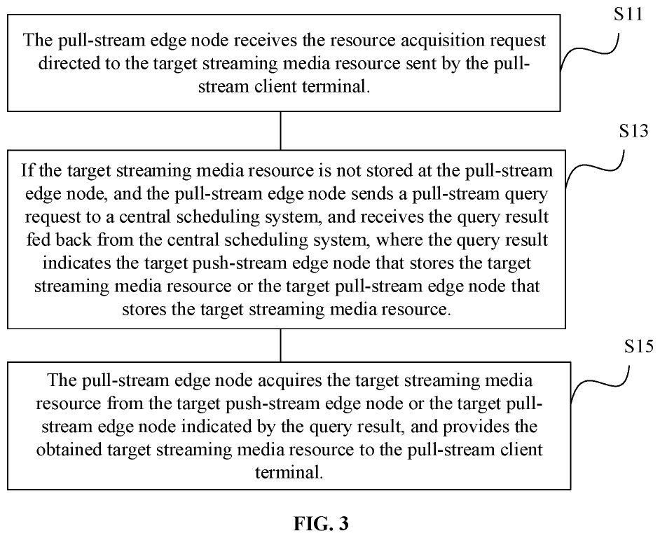

Specifically, referring to FIG. 3, the present disclosure provides a method for distributing a streaming media resource, where the execution subject of the method may be the foregoing pull-stream edge node. As shown in FIG. 3, the method can include the following steps.

S11: The pull-stream edge node receives the resource acquisition request that directs to the target streaming media resource and is sent by the pull-stream client terminal.

In this embodiment, the pull-stream client terminal may be a terminal device used by a user who views an on-demand video or a live video. Of course, the pull-stream client terminal may also be software run by the terminal device. For example, the pull-stream client terminal may be a smart phone, or may be a software such as Youku TV, Tencent Video, and DouYu live TV, etc., run by a smart phone. When the user wants to view the target streaming media resource, the pull-stream client terminal can send a resource acquisition request that directs to the target streaming media resource. The request can be received by a pull-stream edge node in the CDN. The pull-stream edge node may be an edge node with the best communication condition with the pull-stream client terminal, or may be an edge node selected according to a load balancing policy, which is not limited in this disclosure.

In this embodiment, the resource acquisition request usually includes a resource identifier of the target streaming media resource, and the resource identifier may be a uniform resource locator (URL) used to locate the target streaming media resource, and may also be a name of the target streaming media resource, or of course, a combination of the foregoing URL and name. In addition, the resource acquisition request may further include a communication address of the pull-stream client terminal, so that the target streaming media resource may be fed back to the pull-stream client terminal according to the communication address.

S13: If the target streaming media resource is not stored at the pull-stream edge node, and the pull-stream edge node sends a pull-stream query request to a central scheduling system, and receives the query result fed back from the central scheduling system, where the query result indicates the target push-stream edge node that stores the target streaming media resource or the target pull-stream edge node that stores the target streaming media resource.

In this embodiment, after receiving the resource acquisition request, the pull-stream edge node first determines whether the corresponding target streaming media resource is stored locally according to the resource identifier carried in the resource acquisition request. If the target streaming media resource has been stored, the target streaming media resource can be directly fed back to the pull-stream client terminal. If the target streaming media resource is not stored at the pull-stream edge node, the pull-stream query request can be sent to the central scheduling system through the pull-stream query interface provided by the central scheduling system.

In this embodiment, the pull-stream query request may include a resource identifier of the target streaming media resource and node information of the pull-stream edge node. The resource identifier of the target streaming media resource is configured to notify the central scheduling system, which streaming media resource the current user wants to view. The node information of the pull-stream edge node may include information such as a name, an IP address, and an area of the edge node of the pull-stream. The central scheduling system may determine, according to the node information, a node having an optimal communication condition with the pull-stream edge node among the plurality of nodes that store the target streaming media resource.

In this embodiment, after receiving the pull-stream query request, the central scheduling system may query the pull-stream edge node and/or the push-stream edge node that currently store the target streaming media resource according to the resource identifier carrier in the pull-stream query request. It should be noted that, since the push-stream edge node and the source node are at equal level, the streaming media resource can be stored in the push-stream edge node; in addition, since the pull-stream edge node and the level 2 cache node are at equal level, the streaming media resource can also be stored in the pull-stream edge node. In the central scheduling system, information of a streaming media resource that has been currently stored in the CDN may be recorded, and the information may include a resource identifier of the streaming media resource, and node information of a node that stores the streaming media resource. In this way, the central scheduling system can may query the pull-stream edge node and/or the push-stream edge node that currently store the target streaming media resource according to the resource identifier carrier in the pull-stream query request.

In this embodiment, if the number of nodes that store the target streaming media resource obtained by the query is more than one, the central scheduling system may follow an optimal path principle, and determine that the target pull-stream edge node or the target push-stream edge node that matches the pull-stream edge node that sends the pull-stream query request, according to the pull-stream edge node and/or the push-stream edge node obtained by the query. Specifically, the central scheduling system may determine a communication condition between the pull-stream edge node that sends the pull-stream query request and each node that is obtained by the query, and the communication condition may include various information such as a communication delay, a packet loss rate, and a bandwidth consumption, etc. Then, the node with the best communication condition can be used as the target pull-stream edge node or the target push-stream edge node that matches the pull-stream edge node that sends the pull-stream query request. In this way, the determined target pull-stream edge node or the target push-stream edge node and the pull-stream edge node that sends the pull-stream query request may form an optimal transmission path.

In this embodiment, the central scheduling system may feed back the node information of the determined target pull-stream edge node or the node information of the determined target push-stream edge node to the pull-stream edge node that sends the pull-stream query request. The feedback node information may include an IP address of the target pull-stream edge node or the target push-stream edge node.

S15: The pull-stream edge node acquires the target streaming media resource from the target push-stream edge node, or the target pull-stream edge node determined by the query result, and provides the obtained target streaming media resource to the pull-stream client terminal.

In this embodiment, the pull-stream edge node may obtain the target streaming media resource from the corresponding target pull-stream edge node or the target push-stream edge node according to the node information fed back by the central scheduling system. After the target streaming media resource is obtained, the pull-stream edge node may provide the target streaming media resource to the pull-stream client terminal.

In this embodiment, since the pull-stream edge node and the level 2 cache node are at equal level, after the pull-stream edge node acquires the target streaming media resource, the pull-stream edge node may store the target streaming media resources locally. If later a new stream edge node wants to obtain the target streaming media resource, the pull-stream edge node that stores the target streaming media resource can be used as a level 2 cache node to provide the target steaming media resource to a new pull-stream edge node. After the target streaming media resource is stored locally, the pull-stream edge node may feed back the resource identifier of the target streaming media resource and the node information of the pull-stream edge node itself to the central scheduling system, so that the central scheduling system records the node information of the node that currently stores the target streaming media resource.

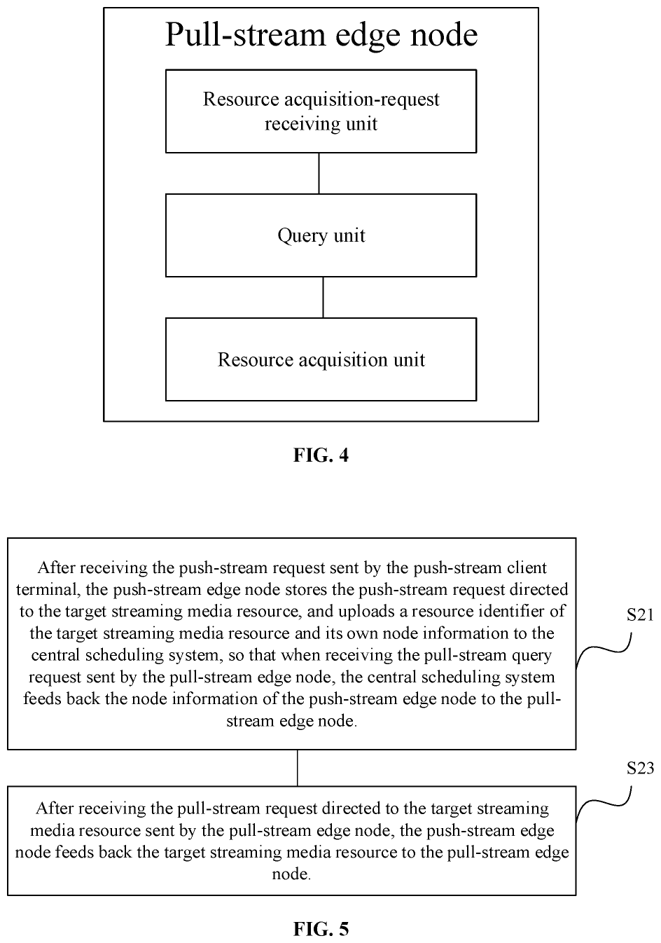

Referring to FIG. 4, the present disclosure further provides a pull-stream edge node, where the pull-stream edge node includes:

a resource acquisition-request receiving unit, configured to receive a resource acquisition request that directs to the target streaming media resource and is sent by the pull-stream client terminal;

a query unit, configured to send a pull-stream query request to the central scheduling system if the target streaming media resource is not stored at the pull-stream edge node, and receive the query result fed back from the central scheduling system, where the query result indicates the target push-stream edge node that stores the target streaming media resource or the target pull-stream edge node that stores the target streaming media resource; and

a resource acquisition unit, configured to obtain the target streaming media resource from the target push-stream edge node, or the target pull-stream edge node determined by the query result.

For the specific functions implemented by the edge node of the pull-stream, reference can be made to the method for distributing the streaming media resources performed by the edge node of the pull-stream, and details are not described herein.

The disclosure further provides a method for distributing a streaming media resource, and the execution subject of the method may be the foregoing push-stream edge node. Referring to FIG. 5, the method may include the following steps.

S21: After receiving the push-stream request sent by the push-stream client terminal, the push-stream edge node stores the push-stream request that directs to the target streaming media resource, and uploads a resource identifier of the streaming media resource and its own node information to the central scheduling system, so that when receiving the pull-stream query request sent by the pull-stream edge node, the central scheduling system feeds back the node information of the push-stream edge node to the pull-stream edge node.

In this embodiment, the push-stream client terminal may be a terminal device used by a user to upload a streaming media resource, or software installed in the terminal device. The user who uploads the streaming media resource may be, for example, an anchor of a live broadcast platform. The terminal device may be, for example, a desktop computer or a smart phone, and the software may be, for example, an application (APP) such as Acfun, Bilibili, Huya broadcasting. When the push-stream client terminal needs to upload the streaming media resource, the push-stream request that directs to the streaming media resource may be sent out, where the push-stream request may include the resource identifier of the streaming media resource. The push-stream request can be received by a push-stream edge node in the CDN. The push-stream edge node may be an edge node having the best communication condition with the push-stream client terminal or may be an edge node selected according to the load balancing policy, which is not limited in this disclosure.

In this embodiment, after the push-stream edge node receives the push-stream request, the streaming media resource directed to by the push-stream request may be locally stored, and the streaming media resource may not be continued to be pushed to the source node, thereby avoiding bandwidth consumption inside the CDN. After the streaming media resource is stored, the push-stream edge node may upload the resource identifier of the streaming media resource and its own node information to the central scheduling system. The resource identifier may be a URL for locating the streaming media resource or may be a name of the streaming media resource, and of course, a combination of the foregoing URL and a name may also be used. The node information of the push-stream edge node may include information such as a name, an IP address, and an area of the push-stream edge node, etc. In this way, the central scheduling system can store the received resource identifier and node information in association. If the pull-stream edge node sends a pull-stream query request that directs to the streaming media resource, the central scheduling system may feed back the node information of the push-stream edge node to the pull-stream edge node, so that the pull-stream edge node can obtain the streaming media resource from the push-stream edge node.

S23: After receiving the pull-stream request that directs to the target streaming media resource and is sent by the pull-stream edge node, the push-stream edge node feeds back the streaming media resource to the pull-stream edge node.

In this embodiment, when the pull-stream edge node receives the resource acquisition request sent by the pull-stream client terminal, if the pull-stream edge node does not cache the corresponding streaming media resource, the pull-stream edge node may follow description in step S13 and send a pull-stream query request to the central scheduling system, so as to obtain node information of the push-stream edge node corresponding to the resource acquisition request from the central scheduling system. If the node information characterizes the push-stream edge node in step S21, the push-stream edge node may receive the pull-stream request that is sent by the pull-stream edge node and directs to the streaming media resource and may feed back the streaming media resource to the pull-stream edge node. It can be seen that, after receiving the push-stream request, the push-stream edge node in the embodiment does not continue to push the corresponding streaming media resource to the source node, but stores the streaming media resource locally, and uploads the resource identifier and own node information of the push-stream edge node to the central scheduling system, so that the push-stream edge node not only undertakes the service of the edge node but also realizes the service of the source node.

The disclosure also provides a push-stream edge node, where the push-stream edge node includes:

an information uploading unit, configured to after the push-stream edge node receiving the push-stream request sent from the push-stream client terminal, store the streaming media resource directed to by the push-stream request and upload the resource identifier of the streaming media resource and the node information of the push-stream edge node to the central scheduling system, so that when receiving the pull-stream query request sent by the pull-stream edge node, the central scheduling system feeds back the node information of the push-stream edge node to the pull-stream edge node; and

a resource feedback unit, configured to after receiving the pull-stream request that directs to the streaming media resource and is sent by the pull-stream edge node, feed back the streaming media resource to the pull-stream edge node.

For the specific functions implemented by the push-stream edge node, reference can be made to the method for distributing the streaming media resource performed by the push-stream edge node, which will not be described here.

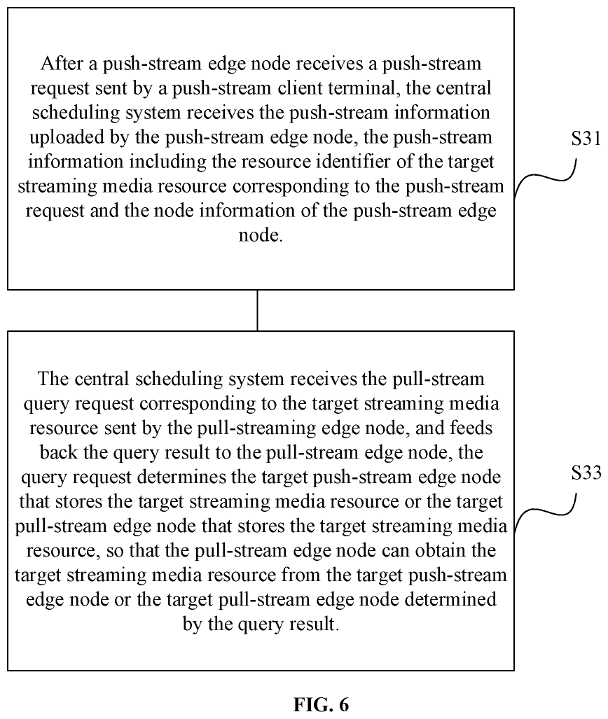

Referring to FIG. 6, the present disclosure further provides a method for distributing a streaming media resource, where the execution subject of the method may be the central scheduling system described above, and the method includes the following steps.

S31: after a push-stream edge node receives a push-stream request sent by a push-stream client terminal, the central scheduling system receives the push-stream information uploaded by the push-stream edge node, the push-stream information including the resource identifier of the streaming media resource directed to by the push-stream request and the node information of the push-stream edge node.

In this embodiment, when the push-stream client terminal needs to upload the streaming media resource, the push-stream request that directs to the streaming media resource may be sent out, where the push-stream request may include the resource identifier of the streaming media resource. The push-stream request can be received by the push-stream edge node in the CDN. After receiving the push-stream request, the push-stream edge node may locally store the streaming media resource directed to by the push-stream request without continuing to push the streaming media resource to the source node, thereby avoiding bandwidth consumption inside the CDN. After the streaming media resource is stored, the push-stream edge node may upload the resource identifier of the streaming media resource and its own node information as push-stream information to the central scheduling system. In this way, the central scheduling system can store the received resource identifier and node information in association.

S33: the central scheduling system receives the pull-stream query request that directs to the target streaming media resource and is sent by the pull-stream edge node, and feeds back the query result to the pull-stream edge node, the query request determines the target push-stream edge node that stores the target streaming media resource or the target pull-stream edge node that stores the target streaming media resource, so that the pull-stream edge node can obtain the target streaming media resource from the target push-stream edge node or the target pull-stream edge node indicated by the query result.

In this embodiment, when the user wants to view the target streaming media resource, the pull-stream client terminal may send a resource acquisition request that directs to the target stream resource to the pull-stream edge node. In this embodiment, after receiving the resource acquisition request, the pull-stream edge node first determines whether the corresponding target streaming media resource is stored locally according to the resource identifier carried in the resource acquisition request. If the target streaming media resource has been stored, the target streaming media resource can be directly fed back to the pull-stream client terminal. If the target streaming media resource is not stored at the edge node, a pull-stream query request may be sent to the central scheduling system through the pull-stream query interface provided by the central scheduling system.

In this embodiment, the pull-stream query request may include a resource identifier of the target streaming media resource and node information of the pull-stream edge node. The resource identifier of the target streaming media resource is configured to notify the central scheduling system, which streaming media resource the current user wants to view. The node information of the pull-stream edge node may include information such as a name, an IP address, and an area of the edge node of the pull-stream. The central scheduling system may determine, according to the node information, a node having an optimal communication condition with the pull-stream edge node among the plurality of nodes that store the target streaming media resource.

In this embodiment, after receiving the pull-stream query request, the central scheduling system may query the pull-stream edge node and/or the push-stream edge node that currently store the target streaming media resource according to the resource identifier carrier in the pull-stream query request. It should be noted that, since the push-stream edge node and the source node are at equal level, the streaming media resource can be stored in the push-stream edge node; in addition, since the pull-stream edge node and the level 2 cache node are at equal level, the streaming media resource can also be stored in the pull-stream edge node. In the central scheduling system, information of a streaming media resource that has been currently stored in the CDN may be recorded, and the information may include a resource identifier of the streaming media resource, and node information of a node that stores the streaming media resource. In this way, the central scheduling system can may query the pull-stream edge node and/or the push-stream edge node that currently store the target streaming media resource according to the resource identifier carrier in the pull-stream query request.

In this embodiment, if the number of nodes that store the target streaming media resource obtained by the query is more than one, the central scheduling system may follow an optimal path principle, and determine that the target pull-stream edge node or the target push-stream edge node that matches the pull-stream edge node that sends the pull-stream query request, according to the pull-stream edge node and/or the push-stream edge node obtained by the query. Specifically, the central scheduling system may determine a communication condition between the pull-stream edge node that sends the pull-stream query request and each node that is obtained by the query, and the communication condition may include various information such as a communication delay, a packet loss rate, and a bandwidth consumption, etc. Then, the node with the best communication condition can be used as the target pull-stream edge node or the target push-stream edge node that matches the pull-stream edge node that sends the pull-stream query request. In this way, the determined target pull-stream edge node or the target push-stream edge node and the pull-stream edge node that sends the pull-stream query request may form an optimal transmission path.

In this embodiment, the central scheduling system may feed back the node information of the determined target pull-stream edge node or the node information of the determined target push-stream edge node to the pull-stream edge node that sends the pull-stream query request. The feedback node information may include an IP address of the target pull-stream edge node or the target push-stream edge node.

In this embodiment, the pull-stream edge node may obtain the target streaming media resource from the corresponding target pull-stream edge node or the target push-stream edge node according to the node information fed back by the central scheduling system. After the target streaming media resource is obtained, the pull-stream edge node may provide the target streaming media resource to the pull-stream client terminal.

In this embodiment, since the pull-stream edge node and the level 2 cache node are at equal level, after the pull-stream edge node acquires the target streaming media resource, the pull-stream edge node may store the target streaming media resources locally. If later a new stream edge node wants to obtain the target streaming media resource, the pull-stream edge node that stores the target streaming media resource can be used as a level 2 cache node to provide the target steaming media resource to a new pull-stream edge node. After the target streaming media resource is stored locally, the pull-stream edge node may feed back the resource identifier of the target streaming media resource and the node information of the pull-stream edge node itself to the central scheduling system, so that the central scheduling system records the node information of the node that currently stores the target streaming media resource.

The disclosure also provides a central scheduling system, the system comprising:

a push-stream information receiving unit, configured to after the push-stream edge node receives the push-stream request sent by the push-stream client terminal, receive the push-stream information uploaded by the push-stream edge node, where the push-stream information includes a resource identifier of the streaming media resource directed to by the push-stream request and node information of the push-stream edge node; and

a query result feedback unit, configured to receive the pull-stream query request that directs to the target streaming media resource and is sent by the pull-stream edge node, and feed back the query result to the pull-stream edge node, the query request determines the target push-stream edge node that stores the target streaming media resource or the target pull-stream edge node that stores the target streaming media resource, so that the pull-stream edge node can obtain the target streaming media resource from the target push-stream edge node or the target pull-stream edge node represented by the query result.

For the specific functions implemented by the central scheduling system, reference can be made to the method for distributing the streaming media resources executed by the central scheduling system, and details are not described herein.

Referring to FIG. 2, the present disclosure further provides a distribution system for streaming media resources, where the system includes a push-stream edge node, a pull-stream edge node, a level 2 cache node, a source node, and a central scheduling system, where:

the push-stream edge node and the source node have the same configuration information, and the pull-stream edge node and the level 2 cache node have the same configuration information; and

the push-stream edge node, the pull-stream edge node, and the central scheduling system are respectively used to execute the corresponding method steps and are not described herein again.

It can be seen from the above that in the technical solution provided by the present disclosure the source node and the push-stream edge node are at equal level, and the level 2 cache node and the pull-stream edge node are at equal level, thereby avoiding a forwarding process of a large number of resources inside the CDN. Specifically, after receiving the push-stream request sent by the push-stream client terminal, the push-stream edge node may not push the corresponding streaming media resource to the source node, but stores the streaming media resource locally, and uploads the resource identifier of the streaming media resource and its own node information to the central scheduling system, to indicate that the streaming media resource is currently stored at the push-stream edge node. After receiving the resource acquisition request sent by the pull-stream client terminal, if the pull-stream edge node does not store the corresponding streaming media resource locally, the pull-stream edge node may send the pull-stream query request to the central scheduling system to obtain the node that currently stores the streaming media resource from the central scheduling system. If the central scheduling system feeds back the node information of the push-stream edge node to the pull-stream client terminal, the pull-stream edge node can directly obtain the corresponding streaming media resource from the push-stream edge node. In this way, the push-stream edge node undertakes both the service of edge node and the service of source node. In addition, after obtaining the required streaming media resource, the stream edge node can perform the storage of the obtained streaming media resource locally, and after the storage, upload the resource identifier and its own node information to the central scheduling system. In this way, if other stream edge nodes need to obtain the streaming media resource, the streaming media resource can be directly obtained from the stream edge node where the streaming media resource is stored, so that the stream edge node not only undertakes the service of the edge node and undertakes the service of the level 2 cache node at the same time. It can be seen that by making the push-stream edge node and the source node at equal level and making the pull-stream edge node and the level 2 cache node at equal level, the process of a large number of resources within the CDN can be avoided, thereby reducing the network traffic consumption inside the CDN.

Through the description of the above embodiments, those skilled in the art can clearly understand that the various embodiments can be implemented by means of software and a necessary general hardware platform, and of course, can also be implemented by hardware. Based on such understanding, the above-described technical solutions may be embodied in the form of software products in essence or in the form of software products, which may be stored in a computer readable storage medium such as ROM/RAM, magnetic discs, optical discs, etc., which include instructions for causing a computer device (which may be a personal computer, server, or network device, etc.) to perform the methods described in various embodiments or portions of the embodiments.

The above are only the preferred embodiments of the present disclosure and are not intended to limit the present disclosure. Any modifications, equivalents, improvements, etc., which are within the spirit and scope of the present disclosure, should be included in the protection of the present disclosure.

1. A method for distributing a streaming media resource, comprising:
receiving, by a pull-stream edge node, a resource acquisition request directed to a target streaming media resource sent by a pull-stream client terminal;
sending, by the pull-stream edge node, a pull-stream query request to a central scheduling system if the target streaming media resource is un-stored at the pull-stream edge node, and receiving a query result fed back by the central scheduling system; wherein the query result indicates a target push-stream edge node that stores the target streaming media resource or a target pull-stream edge node that stores the target streaming media resource; and
obtaining, by the pull-stream edge node, the target streaming media resource from the target push-stream edge node or the target pull-stream edge node indicated by the query result, and providing the obtained target streaming media resource to the pull-stream client terminal.

2. The method according to claim 1, further comprising:
feeding back, if the target streaming media resource is stored at the pull-stream edge node, the target streaming media resource to the pull-stream client terminal.

3. The method according to claim 1, wherein when the pull-stream edge node obtains the target streaming media resource, the method further comprises:
storing locally, by the pull-stream edge node, the target streaming media resource, and feeding back a resource identifier of the target streaming media resource and node information of the pull-stream edge node to the central scheduling system.

4. The method according to claim 1, wherein the resource acquisition request includes a resource identifier of the target streaming media resource; the pull-stream query request includes the resource identifier of the target streaming media resource and node information of the pull-stream edge node.

5. (canceled)

6. A method for distributing a streaming media resource, comprising:
storing, by a push-stream edge node, when receiving a push-stream request sent by a push-stream client terminal, the streaming media resource directed to by the push-stream request, and uploading a resource identifier of the streaming media resource and own node information of the push-stream edge node to a central scheduling system, so that when receiving a pull-stream query request sent by a pull-stream edge node, the central scheduling system feeds back the node information of the push-stream edge node to the pull-stream edge node; and
feeding back, by the push-stream edge node, when receiving the pull-stream request that directs to the streaming media resource and is sent by the pull-stream edge node, the streaming media resource to the pull-stream edge node.

7. The method according to claim 6, wherein the pull-stream edge node is configured to receive a resource acquisition request sent by a pull-stream client terminal, and obtain node information of a push-stream edge node corresponding to the resource acquisition request from the central scheduling system.

8. (canceled)

9. The method according to claim 1 further comprising:
receiving, by the central scheduling system, when a push-stream edge node receives a push-stream request sent by a push-stream client terminal, push-stream information uploaded by the push-stream edge node, the push-stream information including a resource identifier of the streaming media resource directed to by the push-stream request and node information of the push-stream edge node; and
receiving, by the central scheduling system, the pull-stream query request that directs to the target streaming media resource and is sent by the pull-stream edge node, and feeding back a query result to the pull-stream edge node.

10. The method according to claim 9, further comprising:
receiving and storing locally, by the central scheduling system, when the pull-stream edge node stores the target streaming media resource, a resource identifier of the target streaming media resource and node information of the pull-stream edge node sent by the pull-stream edge node.

11. The method according to claim 9, wherein the central scheduling system feeding back the query result to the pull-stream edge node comprises:
querying, by the central scheduling system, the pull-stream edge node and/or the push-stream edge node that currently stores the target streaming media resource, and determining a target pull-stream edge node or a target push-stream edge node matching with the pull-stream edge node that sends the pull-stream query request among the pull-stream edge node and/or the push-stream edge node determined based on the query result, wherein an optimal transmission path is formed between the determined target pull-stream edge node or the target push-stream edge node and the pull-stream edge node that sends the pull-stream query request; and
feeding back, by the central scheduling system, node information of the determined target pull-stream edge node or node information of the determined target push-stream edge node to the pull-stream edge node that sends the pull-stream query request.

12. (canceled)

13. A system for distributing a streaming media resource, comprising:
a source node;
a level 2 cache node;
a push-stream edge node containing same configuration information as the source node and being configured to:
store, when receiving a push-stream request sent by a push-stream client terminal, the streaming media resource directed to by the push-stream request, and
upload a resource identifier of the streaming media resource and own node information of the push-stream edge node to a central scheduling system;
a central scheduling system configured to receive push-stream information uploaded by the push-stream edge node, wherein the push-stream information includes a resource identifier of a streaming media resource directed to by the push-stream request and node information of the push-stream edge node; and
a pull-stream edge node containing same configuration information as the level 2 cache node and being configured to:
receive a resource acquisition request directed to a target streaming media resource sent by a pull-stream client terminal,
send a pull-stream query request to the central scheduling system if the target streaming media resource is not stored at the pull-stream edge node, and receive a query result fed back by the central scheduling system, wherein the query result indicates a target push-stream edge node that stores the target streaming media resource or a target pull-stream edge node that stores the target streaming media resource, and
obtain the target streaming media resource from the target push-stream edge node or the target pull-stream edge node indicated by the query result, and provide the obtained target streaming media resource to the pull-stream client terminal.

14. The system according to claim 13, wherein the push-stream edge node is further configured to feed back, when receiving the pull-stream request that directs to the streaming media resource and is sent by the pull-stream edge node, the streaming media resource to the pull-stream edge node.

15. The system according to claim 13, wherein the pull-stream edge node is further configured to feed back, if the target streaming media resource is stored at the pull-stream edge node, the target streaming media resource to the pull-stream client terminal.

16. The system according to claim 13, wherein when obtaining the target streaming media resource, the pull-stream edge node is further configured to store locally, the target streaming media resource, and feed back a resource identifier of the target streaming media resource and node information of the pull-stream edge node to the central scheduling system.

17. The method according to claim 6, further comprising:
receiving, by the central scheduling system, when the push-stream edge node receives a push-stream request sent by the push-stream client terminal, push-stream information uploaded by the push-stream edge node, the push-stream information including the resource identifier of the streaming media resource directed to by the push-stream request and node information of the push-stream edge node; and
receiving, by the central scheduling system, the pull-stream query request that directs to the target streaming media resource and is sent by the pull-stream edge node, and feeding back a query result to the pull-stream edge node.

18. The method according to claim 17, further comprising:
receiving and storing locally, by the central scheduling system, when the pull-stream edge node stores the target streaming media resource, a resource identifier of the target streaming media resource and node information of the pull-stream edge node sent by the pull-stream edge node.

19. The method according to claim 17, wherein the central scheduling system feeding back the query result to the pull-stream edge node comprises:
querying, by the central scheduling system, the pull-stream edge node and/or the push-stream edge node that currently stores the target streaming media resource, and determining a target pull-stream edge node or a target push-stream edge node matching with the pull-stream edge node that sends the pull-stream query request among the pull-stream edge node and/or the push-stream edge node determined based on the query result, wherein an optimal transmission path is formed between the determined target pull-stream edge node or the target push-stream edge node and the pull-stream edge node that sends the pull-stream query request; and
feeding back, by the central scheduling system, node information of the determined target pull-stream edge node or node information of the determined target push-stream edge node to the pull-stream edge node that sends the pull-stream query request.
